(19) United States
(12) Patent Application Publication
(10) Pub. No.: US 2022/0198183 A1
(43) Pub. Date: Jun. 23, 2022

(54) INFORMATION PROCESSING APPARATUS AND NON-TRANSITORY COMPUTER READABLE MEDIUM

(71) Applicant: FUJIFILM Business Innovation Corp., Tokyo (JP)

(72) Inventor: Shintaro NISHIOKA, Kanagawa (JP)

(73) Assignee: FUJIFILM Business Innovation Corp., Tokyo (JP)

(21) Appl. No.: 17/324,274

(22) Filed: May 19, 2021

(30) Foreign Application Priority Data
Dec. 17, 2020 (JP) 2020-209617

(51) Int. Cl. G06K 9/00; G06N 20/00; G06K 9/46

(52) U.S. Cl. CPC G06K 9/00449; G06K 9/4609; G06K 9/00463; G06N 20/00

(57) ABSTRACT

An information processing apparatus includes a processor configured to: receive an image on a paper sheet having an entry field ready to be filled with information; and present in a user selectable manner three production methods to produce definition information indicating an attribute of information to fill in the entry field, the three production methods including a method in which a user newly produces definition information, a method of reusing definition information that has been produced for another paper sheet and is prepared beforehand, and a method of producing definition information by using results provided by an artificial intelligence having sorted the received paper sheet.

### CROSS-REFERENCE TO RELATED APPLICATIONS

This application is based on and claims priority under 35 USC 119 from Japanese Patent Application No. 2020-209617 filed Dec. 17, 2020.

### BACKGROUND

### (i) Technical Field

The present disclosure relates to an information processing apparatus and a non-transitory computer readable medium.

### (ii) Related Art

Japanese Unexamined Patent Application Publication No. 2015-184815 discloses a form definition production apparatus that produces format definition of a character recognizing form and includes at least a memory and a controller. The memory includes a format definition memory unit that stores format definition of a reuse source form and an image memory unit that stores an image of the reuse source form read by an image reader. The controller includes an item location searching unit and an item association unit. The item location searching unit searches for, on the image of the reuse source form, each read item in accordance with the format definition of the reuse source form. The item association unit moves the read item of the reuse source form in response to the search results provided by the item location searching unit.

Japanese Unexamined Patent Application Publication No. 2005-173730 discloses a form optical character recognition (OCR) program. The form OCR program causes a computer to perform a form OCR process that recognizes, from the image read from a form, characters in an entry field arranged in the form. The form includes entry fields and pre-printed item names of multiple items. The entry fields and the item names are delineated by ruled lines. The form OCR program includes a full-surface OCR processing step and a partial OCR processing step. In the full-surface OCR processing step, the OCR process is performed on the full surface of a form image. A location of an entry frame that delineates the entry field, a location of an item name frame surrounding the item name, and character strings within these frames are recognized. In the partial OCR processing step, an entry field identifying step identifying an entry field on which the OCR process is to be performed again is performed based on resulting information on the full-surface OCR processing step, and the OCR process is partially performed on the identified entry field.

Japanese Unexamined Patent Application Publication No. 2019-159932 discloses an information processing apparatus. The information processing apparatus includes an extraction unit and a display controller. The extraction unit extracts a rectangular region serving as an entry frame corresponding to an entry field from an image on a paper sheet having the entry field on which information is to be entered. The display controller causes a display to display extraction results provided by the extraction unit. The information processing apparatus further includes an image edit unit and a re-extraction unit. In response to an instruction of a user after the displaying of the extraction results, the image edit unit edits the image to extract the rectangular region serving as the entry frame. The re-extraction unit re-extracts the rectangular region serving as the entry frame from the image that reflects the edit results. The information processing apparatus also includes an output unit. The output unit outputs definition information that is to be used to extract information entered in the entry field. The definition information associates the entry frame extracted by the re-extraction unit with an attribute of information to be entered in the entry field.

Information filling in an entry field is extracted from the image of a paper sheet on which the entry field accepting the information is formed. To this end, definition information indicating an attribute of the information to fill in the entry field is to be produced in advance. The production methods of the definition information includes three types of methods. The three types of methods include a method in which a user newly produces definition information, a method of reusing the definition information that has been produced for another paper sheet and is prepared in advance, and a method of producing definition information by using results provided by artificial intelligence that has sorted a received paper sheet. Systems available in the related art support one of the three production methods and users are not allowed to select a production method from the three methods.

### SUMMARY

Aspects of non-limiting embodiments of the present disclosure relate to allowing a user to select a production method of the definition information.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing apparatus including a processor configured to: receive an image on a paper sheet having an entry field ready to be filled with information; and present in a user selectable manner three production methods to produce definition information indicating an attribute of information to fill in the entry field, the three production methods including a method in which a user newly produces definition information, a method of reusing definition information that has been produced for another paper sheet and is prepared beforehand, and a method of producing definition information by using results provided by an artificial intelligence having sorted the received paper sheet.

### BRIEF DESCRIPTION OF THE DRAWINGS

Exemplary embodiment of the present disclosure will be described in detail based on the following figures, wherein:

FIG. 1 illustrates a configuration example of a form system of an exemplary embodiment;

FIG. 2 is a block diagram illustrating a configuration example of an information processing apparatus of the exemplary embodiment;

FIG. 3 is a flowchart illustrating an example of an information processing process of the exemplary embodiment;

FIG. 4 schematically illustrates an example of a production method display screen of the exemplary embodiment;

FIG. 5 schematically illustrates an example of a recommended field reference information display screen of the exemplary embodiment;

FIG. 6 schematically illustrates an example of the production method display screen where a recommended field production icon is displayed in accordance with the exemplary embodiment;

FIG. 7 schematically illustrates an example of a new reference information display screen of the exemplary embodiment;

FIG. 8 schematically illustrates an example of a reuse reference information display screen of the exemplary embodiment;

FIG. 9 schematically illustrates an example of an artificial intelligence (AI) reference information display screen of the exemplary embodiment;

FIG. 10 is a flowchart illustrating an example of a recommended method determination process of the exemplary embodiment;

FIG. 11 is a flowchart illustrating an example of a received image reading process of the exemplary embodiment;

FIG. 12 schematically illustrates an example of a new production screen of the exemplary embodiment;

FIG. 13 schematically illustrates an example of the new production screen when a read entry field is extracted in accordance with the exemplary embodiment;

FIG. 14 schematically illustrates an example of a recommended field production screen of the exemplary embodiment;

FIG. 15 schematically illustrates an example of a reuse screen of the exemplary embodiment; and

FIG. 16 schematically illustrates an example of an AI usage screen of the exemplary embodiment.

### DETAILED DESCRIPTION

Exemplary embodiment is described with reference to the drawings. Like elements and operations are designated with like reference numerals throughout the drawings and the discussion thereof is not duplicated. Dimensions of the drawings are exaggerated for convenience of explanation and different from actual proportion thereof.

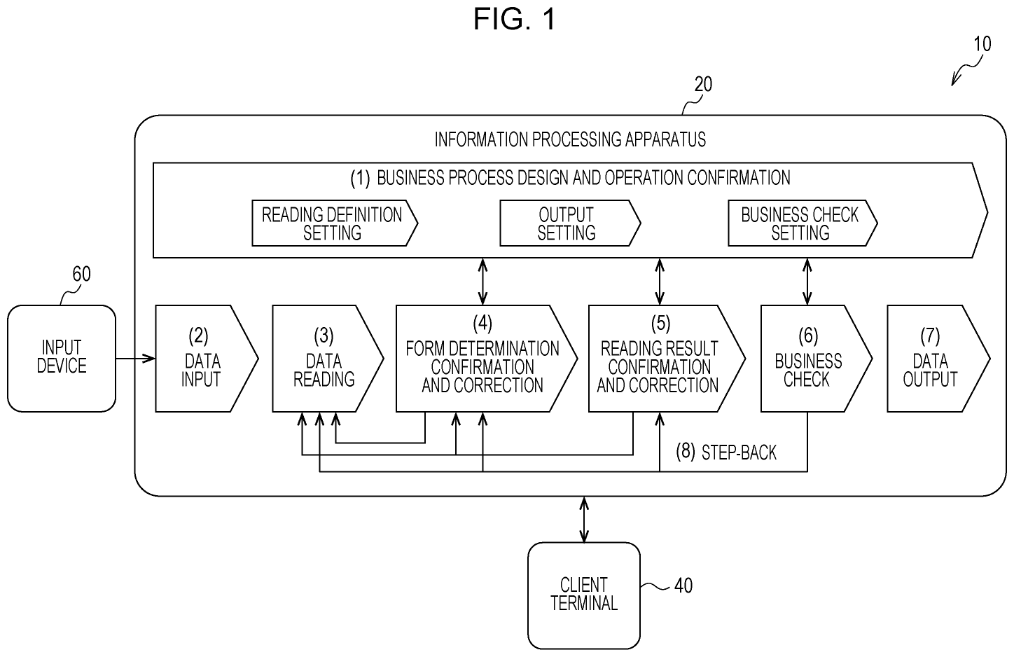

FIG. 1 illustrates the configuration of a form system 10 of the exemplary embodiment.

Referring to FIG. 1, the form system 10 includes an information processing apparatus 20, client terminal 40, and input device 60. These devices are communicably interconnected to each other via a communication network (not illustrated). The communication network may include the Internet, local-area network (LAN), and/or wide-area network (WAN).

The information processing apparatus 20 controls a series of operations including performing an OCR (optical character recognition) process on image data of a document including multiple forms input via the input device 60 and outputting the results of the OCR process to a predetermined output destination. According to the exemplary embodiment, the information processing apparatus 20 is a server computer. However, the information processing apparatus 20 may be a personal computer (PC) or a smart phone. Specific configuration and operations of the information processing apparatus 20 are described below.

The client terminal 40 transmits to the information processing apparatus 20 a variety of instructions related to the OCR process. The instructions include an instruction to start reading information on the image data and an instruction to display read results of the information on the image data. The client terminal 40 also displays a variety of information including the results of the OCR process that the information processing apparatus 20 has performed in response to the variety of instructions received, and a notification related to the OCR process. For example, the client terminal 40 may be a general-purpose computer, such as a server computer or a personal computer (PC). Although a single client terminal 40 is illustrated in FIG. 1, multiple client terminals 40 may also be used properly such that different client terminals 40 operate for different purposes.

The input device 60 inputs to the information processing apparatus 20 the image data serving as a target of the OCR process. The input device 60 may be a general-purpose computer, such as a server computer or a PC, or an image forming apparatus having a scan function, printer function, and fax function. Not only the input device 60 but also the client terminal 40 may input the image data to the information processing apparatus 20.

The configuration of the form system 10 is described below.

In the form system 10, the information processing apparatus 20 performs the OCR process on the image data input via the input device 60 and outputs the results of the OCR process to a predetermined output destination.

In the OCR process, the information processing apparatus 20 controls a variety of operations including a business process design and operation verification operation (1), data input operation (2), data reading operation (3), form determination confirmation and correction operation (4), reading result confirmation and correction operation (5), business check operation (6), data output operation (7), and step-back operation (8). According to the exemplary embodiment, the OCR process includes not only a reading operation to read characters and symbols from the image data but also a post-operation operation, such as a correction operation to characters.

The information processing apparatus 20 automatically performs the business process design and operation verification operation (1), data input operation (2), data reading operation (3), business check operation (6), and data output operation (7) as examples of each control operation. The form determination confirmation and correction operation (4) and reading result confirmation and correction operation (5) are received as an example of control operations when the user inputs them using the client terminal 40. The step-back operation (8) as an example of control operations may be automatically performed by the information processing apparatus 20 or accepted when the user inputs the step-back operation (8) via the client terminal 40.

In the business process design and operation verification operation (1), job rules are produced. The job rules include reading definition setting, output setting, and business check setting. For example, in the reading definition setting, a read range in which information on the image data is read is set in the data reading operation (3). Specifically, a definition of reading an item value as a value to the right of an item extracted as a key may be set. For example, in the output setting, a file format and an output destination of output data to be output in the data output operation (7) are set. In the business check setting, a format, such as an input item in a form serving as a detection target and the number of inputtable characters, in the business check operation (6) is set.

In the data input operation (2), the image data is received from the input device 60. The input image data is registered as a job that serves as an execution unit in the data reading operation (3).

In the data reading operation (3), the information on the image data in the job is read by using a job rule of the job to be executed. The job rule is selected by the user from among the job rules produced in the business process design and operation verification operation (1). For example, in the data reading operation (3), the determination of the form (hereinafter referred to as a “form determination”) is performed on the image data in the job and a character and symbol within the read range are read.

In the form determination confirmation and correction operation (4), the image data in the job is sorted into a record indicating a form in the job in accordance with results of the form determination performed in the data reading operation (3). In the form determination confirmation and correction operation (4), the sorted record is displayed and user confirmation and correction to the form determination are accepted.

In the reading result confirmation and correction operation (5), the results of reading the character and symbol in the read range in the data reading operation (3) are displayed and user confirmation and correction to the read results are accepted.

In the business check operation (6), an error in each prior operation is detected in accordance with the business check setting included in the job rule of the job. The job rule is selected by the user from among the job rules produced in the business process design and operation verification operation (1). The detection results may be displayed to the user.

In the data output operation (7), output data is produced using the output setting included in the job rule of the job. The job rule is selected by the user from among the job rules produced in the business process design and operation verification operation (1). The produced output data is output to a predetermined output destination.

In the step-back operation (8), processing steps back from an operation performed in the OCR process by one or more operations. For example, using the client terminal 40, the user may issue an instruction to perform the step-back operation (8) in the middle of the form determination confirmation and correction operation (4) or the reading result confirmation and correction operation (5). Typically, an instruction of the step-back operation (8) may be issued by the client terminal 40 of an administrator in response to results of an administrator check performed between the business check operation (6) and the data output operation (7).

In the OCR process, the business process design and operation verification operation (1) is performed prior to the data reading operation (3), namely, prior to the start of the operation of the form system 10. Alternatively, the business process design and operation verification operation (1) may be performed in the middle of the operation of the form system 10 that performs the data reading operation (3) or subsequent operation. For example, a job rule produced in the business process design and operation verification operation (1) prior to the operation of the form system 10 may be appropriately corrected in response to the results of the reading result confirmation and correction operation (5) with the form system 10 operating.

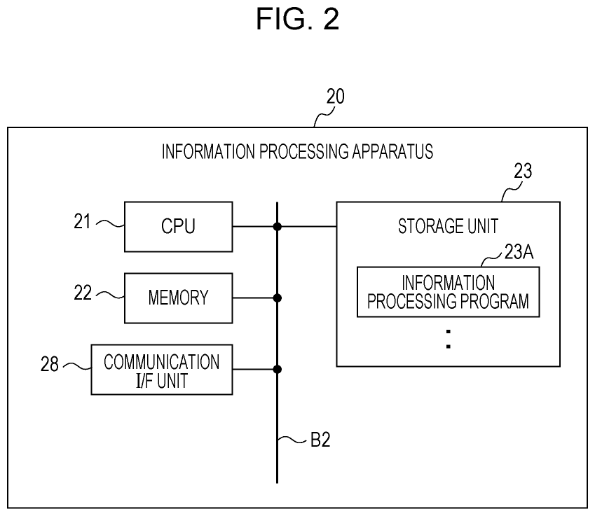

The hardware configuration of the information processing apparatus 20 of the exemplary embodiment is described with reference to FIG. 2. FIG. 2 is a block diagram illustrating the hardware configuration of the information processing apparatus 20 of the exemplary embodiment.

The information processing apparatus 20 of the exemplary embodiment includes a central processing unit (CPU) 21, memory 22 serving as a temporary memory region, non-volatile storage unit 23, and communication interface (I/F) unit 28. These elements are interconnected to each other via a bus B2.

The storage unit 23 may be a hard disk drive (HDD), solid-state drive (SSD), or flash memory. The storage unit 23 serving as a memory medium stores an information processing program 23A. The CPU 21 reads and expands the information processing program 23A on the memory 22 and successively executes processes included in the information processing program 23A.

The communication I/F unit 28 is used for the information processing apparatus 20 to communicate with the client terminal 40 and input device 60. Communications are supported by Ethernet (registered trademark) or wired communication standards, such as fiber distributed data interface (FDDI).

The hardware configuration of the client terminal 40 related to the exemplary embodiment is described below. The client terminal 40 of the exemplary embodiment includes an input unit 44 and display 45.

The input unit 44 includes a keyboard and a pointing device, such as a mouse, and is used to receive a variety of input information.

The display 45 is a liquid-crystal display and displays a variety of information. The display 45 may include a touch panel and serve as the input unit 44.

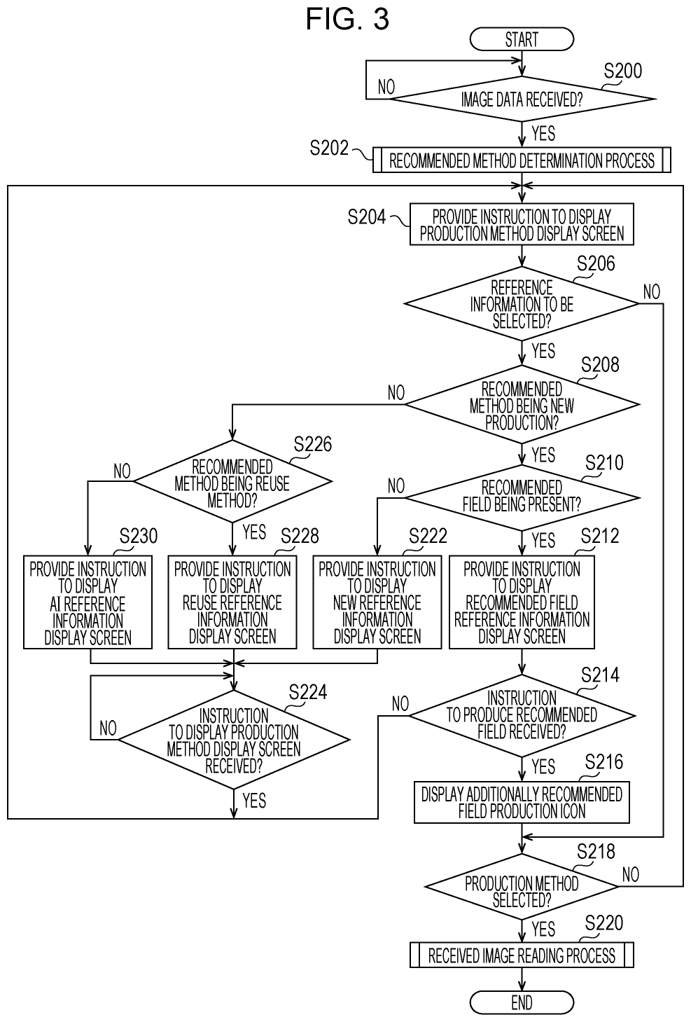

Referring to FIG. 3, the process of the information processing apparatus 20 of the exemplary embodiment is described. When a user instructs the information processing apparatus 20 to perform an information processing process by using the client terminal 40, the CPU 21 executes the information processing program 23A thus performing the information processing process in FIG. 3.

In step S200, the CPU 21 waits on standby until image data on a paper sheet having an entry field ready to be filled in with information is received from the input device 60 via the communication I/F unit 28. In the discussion that follows, the image data received by the CPU 21 is referred to as “received image,” a paper sheet corresponding to the received image is referred to as “received paper sheet,” and an entry field formed on the received paper sheet is referred to as “reception entry field.” According to the exemplary embodiment, the received paper sheets may include a single or multiple paper sheets, each including a form, and information to fill in the reception entry field may include characters and symbols.

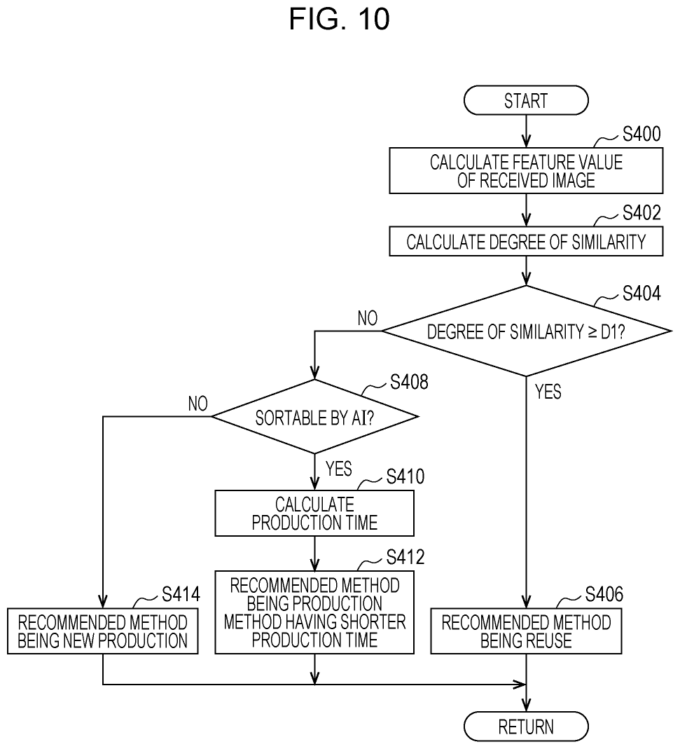

In step S202, the CPU 21 performs a recommended method determination process. The recommended method determination process determines the most recommended method out of production methods that produce definition information indicating an attribute of information that is to fill in the reception entry field. The recommended method determination process of the exemplary embodiment is described below with reference to FIG. 10.

In step S204, the CPU 21 displays on the display 45 a production method display screen in a predetermined format.

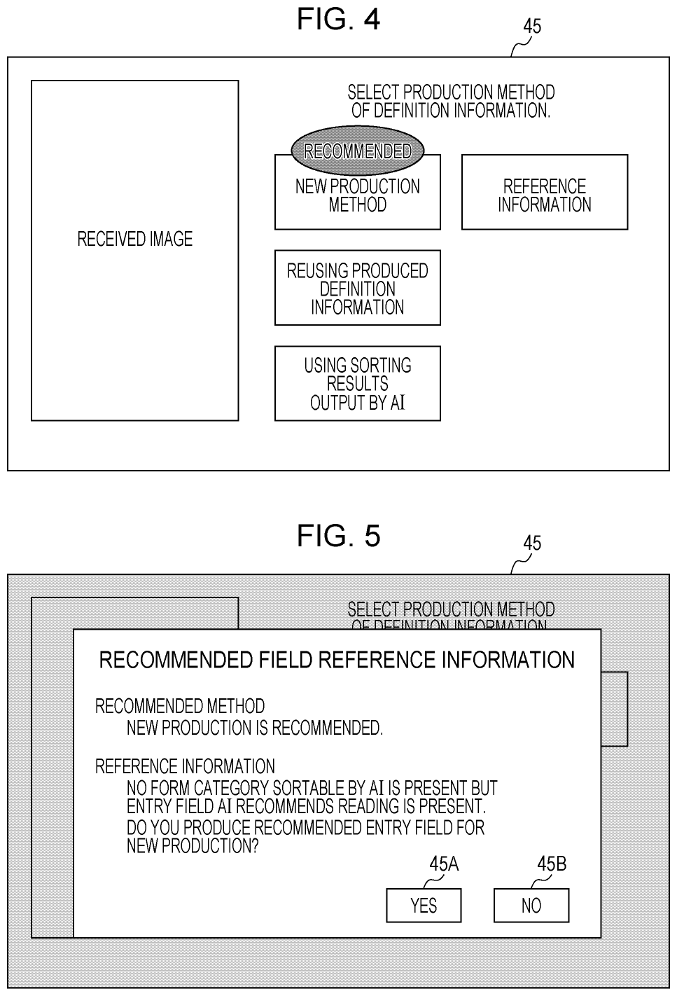

Referring to FIG. 4, the recommended method determination process of the exemplary embodiment displays a received image and a message prompting the user to select the production method of the definition information (definition information production method). The definition information production methods are displayed in a manner such that the user may select one of them and include a method in which the user newly produces definition information, a method in which definition information produced for a paper sheet different from the received paper sheet (hereinafter referred to as the different paper sheet) is reused, and a method in which definition information is produced using results provided by artificial intelligence (AI) having sorted the received image. In the following discussion, the method in which the user newly produces the definition information is referred to as a “new production method,” and the method in which the definition information produced for the different paper sheet is reused is referred to as a “reuse method.” Also, the method in which the results provided by the AI having sorted the received image is referred to as an “AI usage method.”

The production method display screen of the exemplary embodiment may display a method of producing the definition information by combining the three types of methods described above on a per reception entry field basis.

Referring to FIG. 4, a single received image is used. Alternatively, multiple received images may be used. In such a case, the multiple received images may be displayed at a time on the production method display screen or only a received image of a page specified by the user may be displayed on the production method display screen.

The production method display screen of the exemplary embodiment displays an icon that, when specified, displays reference information (hereinafter referred to as a reference information icon) and a recommended method determined via the recommended method determination process (the “new production method” in FIG. 4). It is noted that the production method display screen of the exemplary embodiment does not display the reference information itself. Alternatively, it may be acceptable that the production method display screen may display the reference information itself.

The production method display screen of the exemplary embodiment also displays a button used to display a description of each production method, a button used to temporarily store the settings of a production method selected by the user, and a button used to return to a screen that is used before the reception of the image. For convenience of explanation, these buttons are not illustrated in the drawings.

In step S206, the CPU 21 determines whether the reference information icon has been selected on the production method display screen via the input unit 44. If the yes path is followed in step S206, the CPU 21 proceeds to step S208. If the no path is followed in step S206, the CPU 21 proceeds to step S218.

In step S208, the CPU 21 determines whether the recommended method is the new production method. If the yes path is followed in step S208, the CPU 21 proceeds to step S210.

In step S210, the CPU 21 determines whether the entry field (hereinafter referred to as a recommended field) that the AI recommends reading is present. If the yes path is followed in step S210, the CPU 21 proceeds to step S212.

In step S212, the CPU 21 displays on the display 45 a recommended field reference information display screen in a predetermined format in superimposition on the production method display screen in a grayed-out fashion.

The recommended method (the new production method in FIG. 5) and the reference information are displayed in the recommended field reference information display screen of the exemplary embodiment in FIG. 5. Referring to FIG. 5, the reference information does not include the category of a form indicating the results of the AI that has sorted the received image but includes a message indicating the presence of the recommended field and a message prompting the user to select whether to produce the definition information by producing the recommended field. To produce the definition information by producing the recommended field, the user selects a yes button 45A via the input unit 44. If the recommended field is not produced, the user selects a no button 45B using the input unit 44.

In step S214, the CPU 21 determines whether an instruction to produce the recommended field has been received. In other words, the CPU 21 determines whether the yes button 45A has been selected on the recommended field reference information display screen via the input unit 44. If the yes path is followed in step S214, the CPU 21 proceeds to step S216. If the no path is followed in step S214, in other words, the no button 45B has been selected on the recommended field reference information display screen via the input unit 44, the CPU 21 returns to step S204.

In step S216, the CPU 21 displays a production method display screen on the display 45. The production method display screen additionally includes an icon that, if specified, causes a recommended field production screen described later to be displayed. The icon hereinafter referred to as a recommended field production icon.

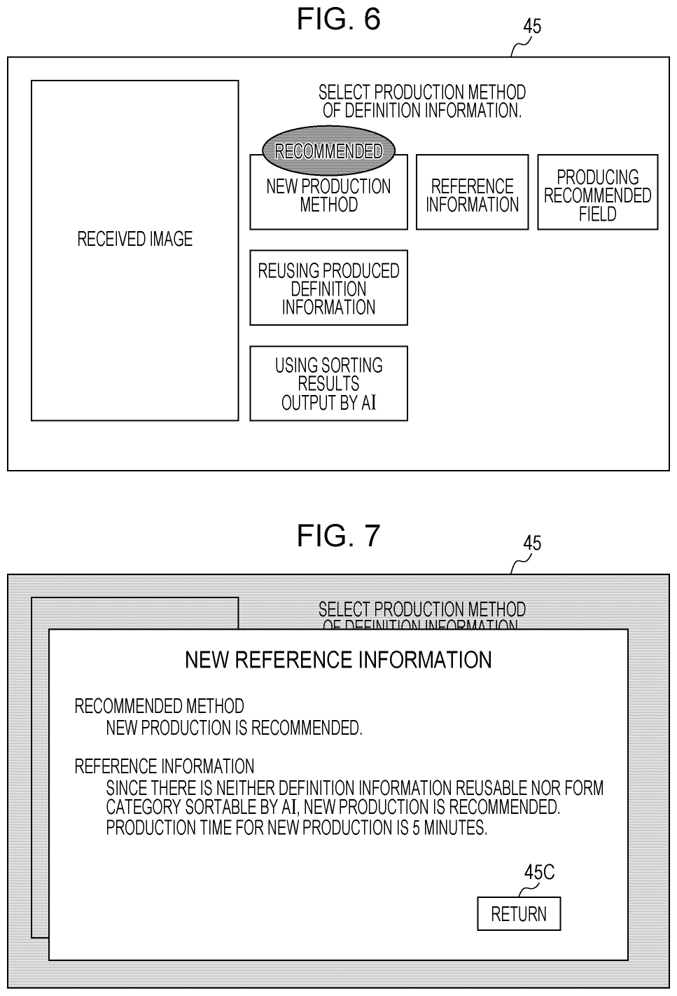

Referring to FIG. 6, the production method display screen of the exemplary embodiment is different from the production method display screen in FIG. 5 in that the recommended field production icon is displayed in FIG. 6.

In step S218, the CPU 21 determines whether any definition information production method or selection of the recommended field production icon has been received via the input unit 44 on the production method display screen within a predetermined time period (for example, 5 minutes). If the yes path is followed in step S218, the CPU 21 proceeds to step S220. If the no path is followed in step S218, the CPU 21 returns to step S204.

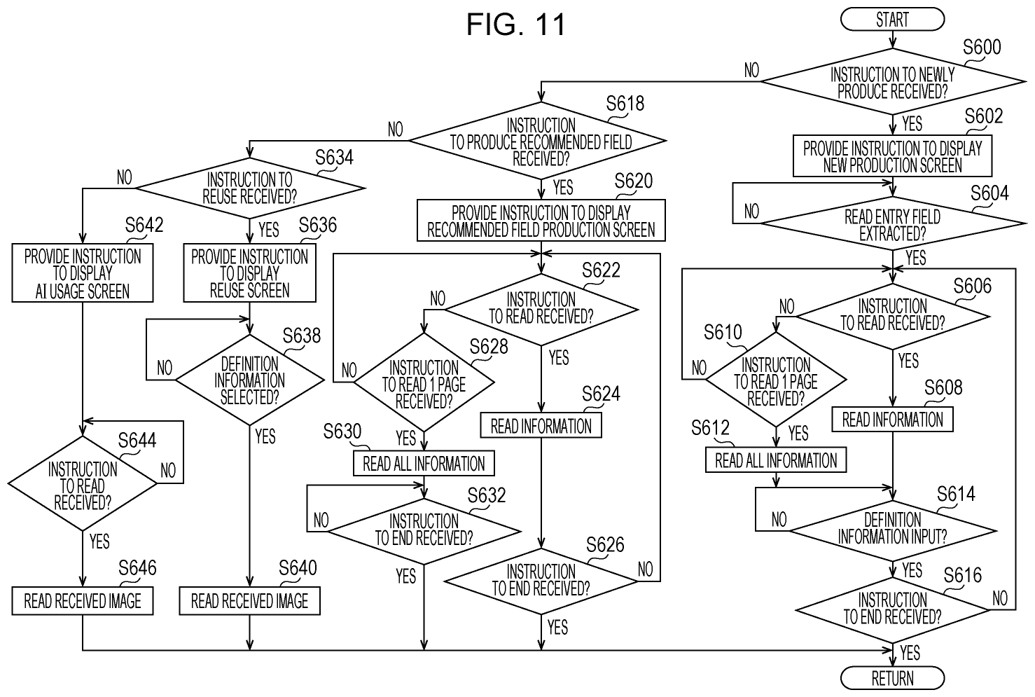

In step S220, the CPU 21 performs a received image reading process to read the received image and ends the information processing process. The received image reading process is described below with reference to FIG. 11.

Returning to step S210, the CPU 21 proceeds to step S222 if the no path is followed. In step S222, the CPU 21 displays a new reference information display screen in a predetermined format in superimposition on a grayed-out production method display screen on the display 45.

Referring to FIG. 7, the recommended method (the “new production method” in FIG. 7) and the reference information are displayed on the new reference information display screen of the exemplary embodiment. Since reusable definition information and a category of a form sortable by the AI are not available in the example in FIG. 7, a message recommending the new production method is displayed. Displayed as the reference information is production time when the definition information is produced in accordance with the new production method (5 minutes in FIG. 7). The user may check the recommended method and reception entry field. To return to the production method display screen, the user selects a return button 45C via the input unit 44.

In step S224, the CPU 21 determines whether an instruction to display the production method display screen has been received. In other words, the CPU 21 determines whether the return button 45C has been selected via the input unit 44 on the new reference information display screen, reuse reference information display screen, or AI reference information display screen. If the yes path is followed in step S224, the CPU 21 returns to step S204. If the no path is followed in step S224, the CPU 21 waits on standby until the yes path is followed. The reuse reference information display screen and the AI reference information display screen are described below.

Returning to step S208, if the no path is followed, the CPU 21 proceeds to step S226. In step S226, the CPU 21 determines whether the recommended method is the reuse method. If the yes path is followed in step S226, the CPU 21 proceeds to step S228. If the no path is followed in step S226, in other words, if the recommended method is the AI usage method, the CPU 21 proceeds to step S230.

In step S228, the CPU 21 displays the reuse reference information display screen in a predetermined format in superimposition on the grayed-out production method display screen on the display 45 and proceeds to step S224.

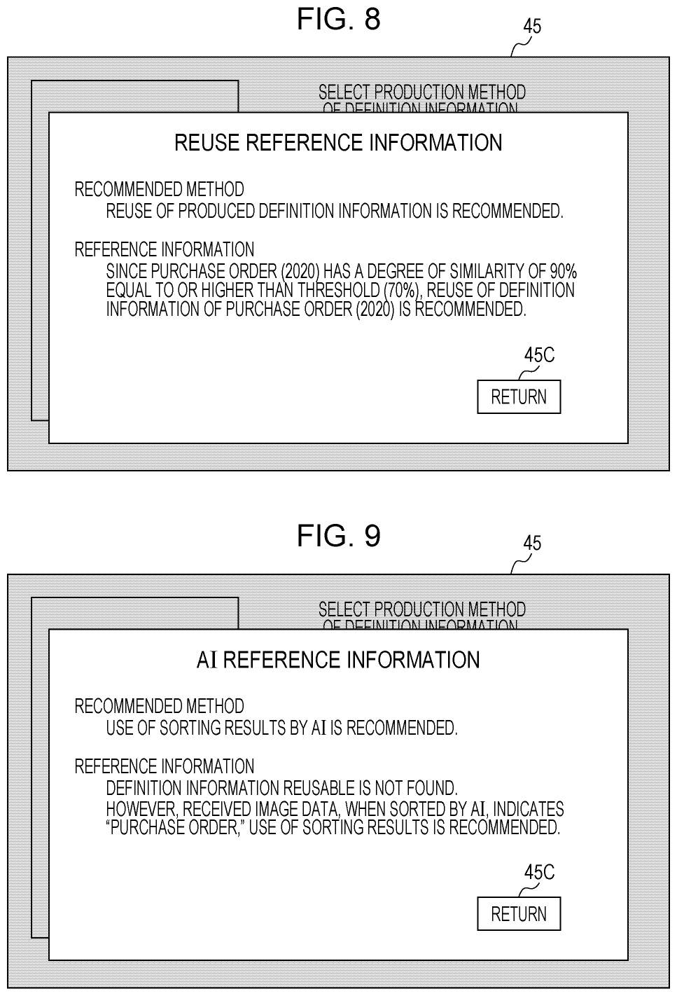

Referring to FIG. 8, the reuse reference information display screen of the exemplary embodiment displays the recommended method (the reuse method in FIG. 8) and the reference information. Since the degree of similarity of another paper sheet (the purchase order (2020) in FIG. 8) is equal to or above a predetermined threshold Dl (70% in FIG. 8), the reference information indicates a message recommending the reuse of the definition information of the other paper sheet. The user may check the recommended method and reference information. To return to the production method display screen, the user selects the return button 45C via the input unit 44.

In step S230, the CPU 21 displays the AI reference information display screen in a predetermined format in superimposition on the grayed-out production method display screen on the display 45 and proceeds to step S224.

Referring to FIG. 9, the AI reference information display screen of the exemplary embodiment displays the recommended method (the AI usage method in FIG. 9) and the reference information. Referring to FIG. 9, the reference information does not include reusable definition information. Since the received image is sortable by the AI (the example of the category of the form in FIG. 9 is a “purchase order”), the reference information includes a message indicating that the use of the sorting results is recommended. The user checks the recommended method and reference information. To return the production method display screen, the user selects the return button 45C via the input unit 44.

According to the exemplary embodiment, the categories of forms include the purchase order, invoice, and receipt. The categories of forms may further include an application form and a combination of these forms.

According to the exemplary embodiment, a recommended reference screen, new reference screen, reuse reference screen, and AI reference screen are displayed in superimposition on the grayed-out production method display screen on the display 45. These screens may be displayed on the display 45 without being superimposed on the production method display screen.

According to the exemplary embodiment, the reference information includes information that is predetermined on each of three types of production methods and indicates the basis why the recommended method displayed on the production method display screen is determined as the most recommended production method. Alternatively, the reference information may include simply only information predetermined on each of the three types of methods.

Specifically, the reference information in the new production method may include a production time when the definition information is produced in accordance with the corresponding method, information indicating another paper sheet having the highest degree of similarity and the value of the highest degree of similarity, and the number of recommended fields. The reference information in the reuse method may include information indicating the other paper sheet having the highest degree of similarity and the value of the highest degree of similarity, and the application rate of a reusable entry field in the other paper sheet. If multiple pieces of the information are present, the reference information in the reuse method may include a rank that reflects the degree of similarity or the height of application rate. The reference information in the AI usage method may include the category of form, the number of entry fields in the category, and comparison results that are obtained when the production time of the definition information produced in the new production method is compared with the production time of the definition information produced in the AI usage method.

The recommended method determination process of the exemplary embodiment is described in detail below with reference to FIG. 10.

In step S400 in FIG. 10, the CPU 21 calculates a feature value of the received image (hereinafter referred to as a reception feature value). Specifically, the CPU 21 calculates as the reception feature value at least one of features including the position of the reception entry field, the size of the reception entry field, and a ratio of characters filling in the reception entry field. Each of the reception feature values is normalized into a value falling within a range from 0 or higher to 1 or lower.

In step S402, the CPU 21 calculates the degree of similarity between the received image and each of the remaining paper sheets. Specifically, the CPU 21 reads from the storage unit 23 the feature value of each of the other paper sheets and calculates a difference of distance between the reception feature value and the feature value of each of the other paper sheets. For example, the CPU 21 calculates the sum of squares of differences of distance of the feature values or the sum of absolute values of distances of the feature values as each difference of distance between the reception feature value and the feature value of each of the other paper sheets. The CPU 21 calculates the sum or the weight sum of differences of distance, thereby calculating the degree of similarity between the received image and each of the other paper sheets.

In step S404, the CPU 21 determines whether there is any paper sheet having a degree of similarity equal to or above a threshold Dl with the received image from among the degrees of similarity calculated in step S402. If the yes path is followed in step S404, the CPU 21 proceeds to step S406. If the no path is followed in step S404, the CPU 21 proceeds to step S408.

In step S406, the CPU 21 completes the recommended method determination process with the recommended method being the reuse method. When the recommended method determination process ends, the CPU 21 proceeds to step S204 in the information processing process (see FIG. 3).

In step S408, the CPU 21 determines whether the received image is sortable by the AI. Specifically, the CPU 21 determines whether the AI is able to sort the received image into the category of form in accordance with the reception feature value. If the yes path is followed in step S408, the CPU 21 proceeds to step S410. If the no path is followed in step S408, the CPU 21 proceeds to step S414.

In step S410, based on the types of the reception entry fields and the number reception entry fields, the CPU 21 calculates the production time when the definition information is produced via the AI usage method and also calculates the production time when the definition information is produced via the new production method.

In step S412, the CPU 21 completes the recommended method determination process with the AI usage method or the new production method as the recommended method, whichever has a shorter production time.

In step S414, the CPU 21 completes the recommended method determination process with the recommended method being the new production method. In step S414, the CPU 21 also determines the production time when the definition information is produced via the new production method.

In the recommended method determination process of the exemplary embodiment, after determining whether any other paper sheet having the degree of similarity equal to or above the threshold Dl is present (step S402), the CPU 21 determines whether the received image is sortable by the AI (step S408). Alternatively, after determining whether the received image is sortable by the AI, the CPU 21 may determine whether any other paper sheet having the degree of similarity equal to or above the threshold Dl is present. If the user produces definition information for the first time, the CPU 21 may execute the operation in step S408 without executing the operation in step S402.

A received image reading process of the exemplary embodiment is described below with reference to FIG. 11.

In step S600 in FIG. 11, the CPU 21 determines whether to receive an instruction to newly produce definition information. In other words, the CPU 21 determines whether the new production has been selected on the production method display screen via the input unit 44. If the yes path is followed in step S600, the CPU 21 proceeds to step S602.

In step S602, the CPU 21 displays a new production screen in a predetermined format on the display 45.

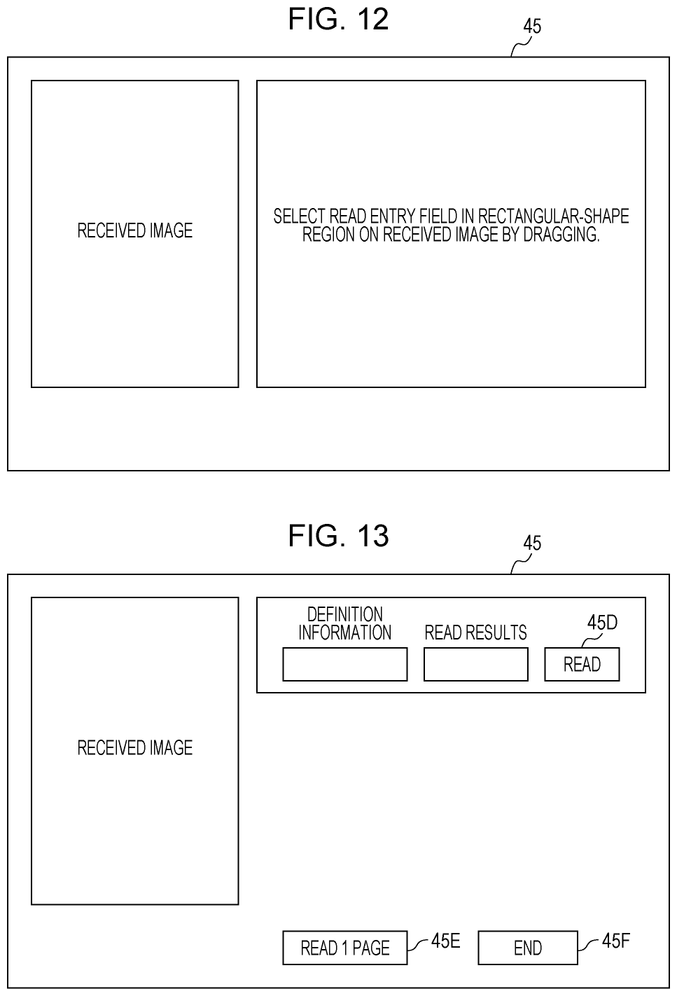

Referring to FIG. 12, the new production screen of the exemplary embodiment displays the received image and a message prompting the user to select an entry field (hereinafter referred to as a “read entry field”) used to read information from the received image by dragging a selection rectangle. Using the input unit 44, the user extracts the read entry field by dragging the selection rectangle to the read range of the information on the received image.

In step S604, the CPU 21 waits on standby until the read entry field is extracted on the production method display screen.

When the user has extracted the read entry field, the new production screen of the exemplary embodiment displays in association with each other a field receiving the definition information corresponding to the read entry field, read results, and read button 45D as illustrated in FIG. 13. In other words, the new production screen of the exemplary embodiment displays in association with each other the field receiving an attribute of the information to fill in the read entry field, read results of the information filling in the read entry field, and the read button 45D used to read the information filling in the read entry field. The new production screen of the exemplary embodiment further displays a read 1-page button 45E used to read all the information filling in all the read entry fields extracted and end 45F that is used to end the received image reading process.

In step S606, the CPU 21 determines whether an instruction to read the information filling in the read entry field has been received. In other words, the CPU 21 determines whether the read button 45D has been selected on the new production screen via the input unit 44. If the yes path is followed in step S606, the CPU 21 proceeds to step S608. If the no path is followed in step S606, the CPU 21 proceeds to step S610.

In step S608, the CPU 21 reads information filling in the read entry field corresponding to the read button 45D selected and displays the read results on the new production screen.

In step S610, the CPU 21 determines whether an instruction to read the information filling in all the read entry fields has been received. In other words, the CPU 21 determines whether the read 1-page button 45E has been selected on the new production screen via the input unit 44. If the yes path is followed in step S610, the CPU 21 proceeds to step S612. If the no path is followed in step S610, the CPU 21 returns to step S606.

In step S612, the CPU 21 reads all the information filling in all the read entry fields extracted and displays read results on the new production screen.

In step S614, the CPU 21 waits on standby until the definition information corresponding to all the read entry fields extracted is input via the input unit 44.

In step S616, the CPU 21 waits on standby until an instruction to end the received image reading process is received. Specifically, if the end 45F is selected on the new production screen via the input unit 44, the CPU 21 ends the received image reading process. If the end 45F is not selected, the CPU 21 returns to step S606. When the received image reading process is complete, the CPU 21 ends the information processing process (see FIG. 3).

Returning to step S600, if the no path is followed, the CPU 21 proceeds to step S618. In step S618, the CPU 21 determines whether an instruction to produce the definition information by producing the recommended field has been received. In other words, the CPU 21 determines whether the recommended field production icon has been selected on the production method display screen via the input unit 44. If the yes path is followed in step S618, the CPU 21 proceeds to step S620.

In step S620, the CPU 21 displays the recommended field production screen in a predetermined format on the display 45.

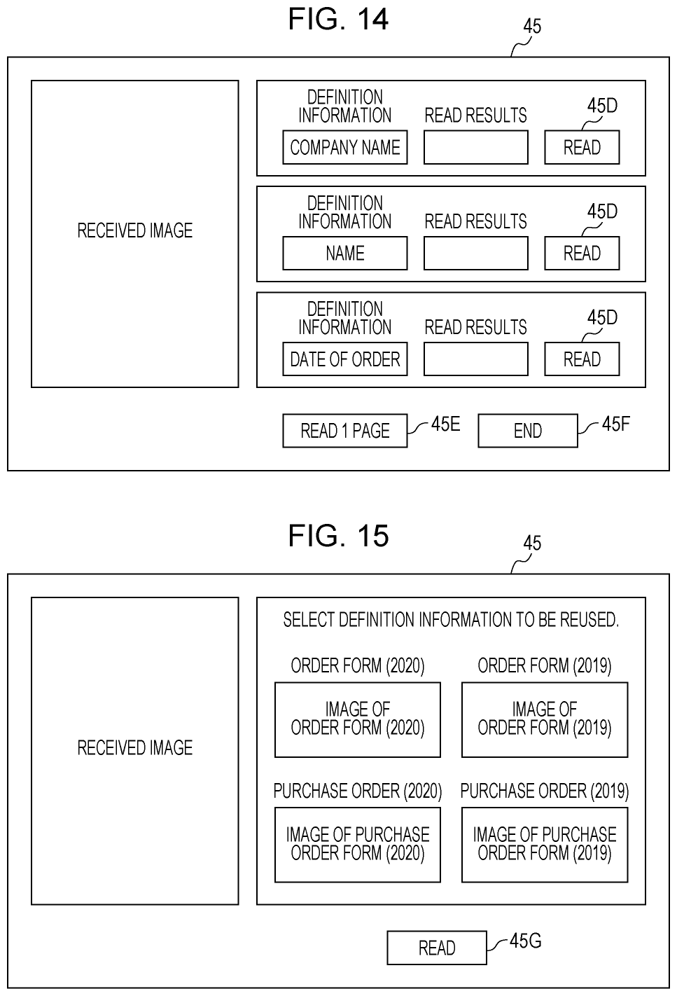

Referring to FIG. 14, the recommended field production screen of the exemplary embodiment displays, in association with each other the received image, the received image, definition information corresponding to the recommended field produced by the AI, read results, and the read button 45D. In other words, the recommended field production screen displays the attribute of the information to fill in the recommended field, read results of the information filling in the recommended field, and the read button 45D used to read the information filling in the recommended field. The recommended field production screen of the exemplary embodiment further includes the read 1-page button 45E used to read all the information filling in all the recommended fields and the end 45F to end the received image reading process.

After performing the operation in step S620, the CPU 21 may extract the read entry field and receive the inputting of the definition information corresponding to the read entry field. The user may thus produce the definition information by combining the recommended field produced by the AI and the read entry field extracted by the user.

The new production screen and the recommended field production screen of the exemplary embodiment displays a button used to temporarily store the read results, a button used to cancel the read results, and a button used to return to a screen (the production method display screen) displayed prior to these screens. For convenience of explanation, these screens are not illustrated.

In step S622, the CPU 21 determines whether an instruction to read the information filling in the recommended field has been received. In other words, the CPU 21 determines whether the read button 45D has been selected on the recommended field production screen via the input unit 44. If the yes path is followed in step S622, the CPU 21 proceeds to step S624. If the no path is followed in step S622, the CPU 21 proceeds to step S628.

In step S624, the CPU 21 reads the information filling in the recommended field corresponding to the read button 45D selected in step S622 and displays the read results on the recommended field production screen.

In step S626, the CPU 21 determines whether an instruction to end the received image reading process has been received. Specifically, if the end 45F is selected on the recommended field production screen via the input unit 44, the CPU 21 ends the received image reading process. If the end 45F is not selected, the CPU 21 returns to step S622.

In step S628, the CPU 21 determines whether an instruction to read the information filling all the recommended fields has been received. In other words, the CPU 21 determines whether the read 1-page button 45E has been selected on the recommended field production screen via the input unit 44. If the yes path is followed in step S628, the CPU 21 proceeds to step S630. If the no path is followed in step S628, the CPU 21 returns to step S622.

In step S630, the CPU 21 reads the information filling in all the recommended fields and displays the read results on the recommended field production screen.

The CPU 21 may display, as the read results on the recommended field production screen, results read from the information filling in the recommended fields without displaying the read button 45D and read 1-page button 45E on the recommended field production screen.

In step S632, the CPU 21 waits on standby until an instruction to end the received image reading process is received. Specifically, if the display 45 is selected on the recommended field production screen via the input unit 44, the CPU 21 ends the received image reading process. If the end 45F remains unselected, the CPU 21 waits until the end 45F is selected.

Returning to step S618, if the no path is followed, the CPU 21 proceeds to step S634. In step S634, the CPU 21 determines whether an instruction to produce the definition information by reusing the definition information produced in another paper sheet has been received. In other words, the CPU 21 determines whether the “reuse method” has been selected on the production method display screen via the input unit 44. If the yes path is followed in step S634, the CPU 21 proceeds to step S636.

In step S636, the CPU 21 displays the reuse screen in a predetermined format on the display 45.

Referring to FIG. 15, the reuse screen of the exemplary embodiment displays the received image and images of other paper sheets, each having a degree of similarity equal to or above the threshold Dl. The user selects a read button 45G after selecting one image having the definition information the user desires to reuse from among the images of the other paper sheets. The reuse screen of the exemplary embodiment may further display the received image and the degrees of similarity of the other paper sheets displayed. Moreover, if the displayed image corresponds to multiple other paper sheets, the reuse screen of the exemplary embodiment may display the images of all pages or only the image of a page specified by the user.

In step S638, the CPU 21 waits on standby until the selection of one of the images of the other paper sheets displayed and the selection of the read button 45G are received on the reuse screen.

In step S640, the CPU 21 reads the received image by reusing the definition information of the other paper sheet selected in step S638 and then ends the received image reading process.

Returning to step S634, if the no path is followed, in other words, if an instruction to produce the definition information by using the sorting results of the AI on the received image has been received, the CPU 21 proceeds to step S642. In step S642, the CPU 21 displays an AI usage screen in a predetermined format on the display 45.

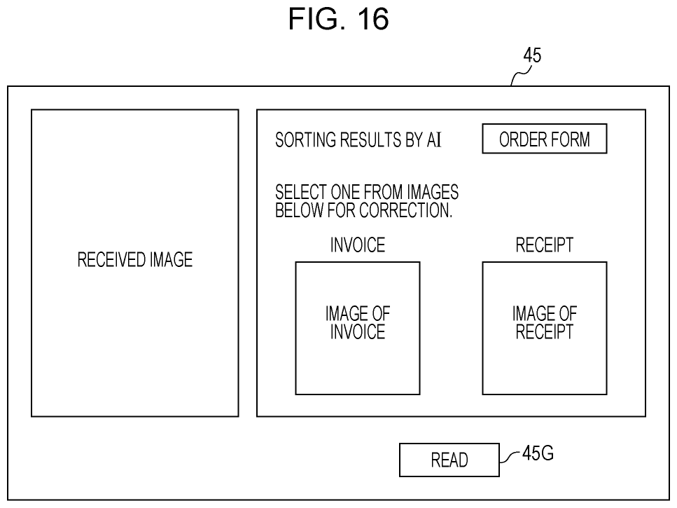

Referring to FIG. 16, the AI usage screen of the exemplary embodiment displays the received image, a category (an “order form” in FIG. 16) of a form sorted by the AI, and the images of categories of pre-stored forms (“invoice” and “receipt” in FIG. 16) excluding the category of the order form. The user selects only the read button 45G in order to produce the definition information by using the category of the form sorted by the AI. On the other hand, the user selects the image of the displayed form and the read button 45G in order to produce the definition information by using the category other than the category of the form sorted by the AI.

The reuse screen and AI usage screen of the exemplary embodiment display a button to return to the production method display screen and a button to display another remaining sheet other than the remaining sheet displayed on these screens or a form category other than the category of the form. For convenience of explanation, these buttons are not illustrated.

In step S644, the CPU 21 waits on standby until the selection of the read button 45G displayed on the AI usage screen is received.

In step S646, the CPU 21 reads the received image by using the category of the form sorted by the AI or the definition information on the category corresponding to the selected image and ends the received image reading process.

According to the exemplary embodiment, the production method of the definition information, recommended production method, and reference information are presented via the display 45 in the client terminal 40 but alternatively, may be presented via voice from a speaker on the client terminal 40.

In the exemplary embodiment above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the exemplary embodiment above, the term “processor” is broad enough to encompass one processor or plural processors in collaboration which are located physically apart from each other but may work cooperatively. The order of operations of the processor is not limited to one described in the embodiments above, and may be changed.

According to the exemplary embodiment, the information processing program 23A is stored on the storage unit 23. The storage destination of the information processing program is not limited to the storage unit 23. The information processing program 23A of the exemplary embodiment may be distributed in a recorded form on a computer readable recording medium. For example, the information processing program 23A of the exemplary embodiment may be provided in a recorded form on an optical disk, such as a compact-disc read-only memory (CD-ROM) or digital versatile disc ROM (DVD-ROM). The information processing program 23A may be distributed in a recorded form on a semiconductor memory, such as a universal serial bus (USB) memory or a memory card. The information processing program 23A may be acquired from an external apparatus via the communication I/F unit 28.

According to the exemplary embodiment, the information processing process is implemented by a software configuration in which a computer performs a computer program. The disclosure is not limited to this method. The information processing process may also be implemented by a hardware configuration or a combination of the hardware and software configurations.

The information processing apparatus 20 has been described for exemplary purposes. Without departing from the scope of the disclosure, the information processing apparatus 20 may be modified with a portion thereof deleted or a new portion added thereto.

The flow of the information processing program (see FIG. 3) has also been described for exemplary purposes. Without departing from the scope of the disclosure, the information processing program may be modified by deleting an operation therefrom, adding a new operation thereto, or changing the order of the operations.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An information processing apparatus comprising:
a processor configured to:
receive an image on a paper sheet having an entry field ready to be filled with information; and
present in a user selectable manner three production methods to produce definition information indicating an attribute of information to fill in the entry field, the three production methods including a method in which a user newly produces definition information, a method of reusing definition information that has been produced for another paper sheet and is prepared beforehand, and a method of producing definition information by using results provided by an artificial intelligence having sorted the received paper sheet.

2. The information processing apparatus according to claim 1, wherein the processor is configured to present at least one of a most recommended method of the three production methods and/or a piece of reference information determined on each of the three production methods.

3. The information processing apparatus according to claim 2, wherein the most recommended production method is determined by using a degree of similarity between a feature value of the received paper sheet and a feature value of the other paper sheet.

4. The information processing apparatus according to claim 3, wherein the processor is configured to present as the most recommended production method the method of reusing the definition information if the degree of similarity is equal to or above a predetermined threshold.

5. The information processing apparatus according to claim 3, wherein the processor is configured to, if the degree of similarity is lower than the predetermined threshold, present as the most recommended production method the method in which the user newly produces the definition information or the method of producing the definition information by using the results provided by the artificial intelligence, whichever has a short production time used to produce the definition information.

6. The information processing apparatus according to claim 4, wherein the processor is configured to, if the degree of similarity is lower than the predetermined threshold value, present as the most recommended production method the method in which the user newly produces the definition information or the method of producing the definition information by using the results provided by the artificial intelligence, whichever has a shorter production time used to produce the definition information.

7. The information processing apparatus according to claim 2, wherein the reference information in the method in which the user newly produces the definition information indicates a production time used to produce the definition information in the method in which the user newly produces the definition information.

8. The information processing apparatus according to claim 3, wherein the reference information in the method in which the user newly produces the definition information indicates a production time used to produce the definition information in the method in which the user newly produces the definition information.

9. The information processing apparatus according to claim 4, wherein the reference information in the method in which the user newly produces the definition information indicates a production time used to produce the definition information in the method in which the user newly produces the definition information.

10. The information processing apparatus according to claim 5, wherein the reference information in the method in which the user newly produces the definition information indicates a production time used to produce the definition information in the method in which the user newly produces the definition information.

11. The information processing apparatus according to claim 6, wherein the reference information in the method in which the user newly produces the definition information indicates a production time used to produce the definition information in the method in which the user newly produces the definition information.

12. The information processing apparatus according to claim 2, wherein the reference information in the method of reusing the definition information indicates a paper sheet having a highest degree of similarity to a feature value of the received paper sheet.

13. The information processing apparatus according to claim 3, wherein the reference information in the method of reusing the definition information indicates a paper sheet having a highest degree of similarity to the feature value of the received paper sheet.

14. The information processing apparatus according to claim 4, wherein the reference information in the method of reusing the definition information indicates a paper sheet having a highest degree of similarity to the feature value of the received paper sheet.

15. The information processing apparatus according to claim 5, wherein the reference information in the method of reusing the definition information indicates a paper sheet having a highest degree of similarity to the feature value of the received paper sheet.

16. The information processing apparatus according to claim 6, wherein the reference information in the method of reusing the definition information indicates a paper sheet having a highest degree of similarity to the feature value of the received paper sheet.

17. The information processing apparatus according to claim 7, wherein the reference information in the method of reusing the definition information indicates a paper sheet having a highest degree of similarity to a feature value of the received paper sheet.

18. The information processing apparatus according to claim 2, wherein the reference information in the method of producing the definition information by using the results provided by the artificial intelligence indicates the results provided by the artificial intelligence having sorted the received paper sheet.

19. The information processing apparatus according to claim 1, wherein the processor is configured to present a method that produces definition information by combining the three production methods on a per entry field basis.

20. A non-transitory computer readable medium storing a program causing a computer to execute a process for processing information, the process comprising:
receiving an image on a paper sheet having an entry field ready to be filled with information; and
presenting in a user selectable manner three production methods to produce definition information indicating an attribute of information to fill in the entry field, the three production methods including a method in which a user newly produces definition information, a method of reusing definition information that has been produced for another paper sheet and is prepared beforehand, and a method of producing definition information by using results provided by an artificial intelligence having sorted the received paper sheet.
